(19) United States
(12) Patent Application Publication
(10) Pub. No.: US 2010/0096319 A1
(43) Pub. Date: Apr. 22, 2010

(54) SEPARATOR ASSEMBLY

(75) Inventors: Philip Paul Beauchamp, Rexford, NY (US); Daniel Jason Erno, Clifton Park, NY (US); Dean David Marschke, Eden Prairie, MN (US); Michael Kent Cueman, Yorktown, VA (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/330,536

(22) Filed: Dec. 9, 2008

Related U.S. Application Data
(60) Provisional application No. 61/111,366, filed on Nov. 5, 2008.
(60) Provisional application No. 61/106,219, filed on Oct. 17, 2008.

(51) Int. Cl. B01D 69/04; B32B 37/00

(52) U.S. Cl. 210/500.23; 156/188

(57) ABSTRACT

A separator assembly is provided comprising a membrane stack assembly comprising a feed carrier layer, a permeate carrier layer, and a membrane layer, and a central core element comprising a concentrate exhaust conduit and a permeate exhaust conduit; wherein the concentrate exhaust conduit and the permeate exhaust conduit are separated by a first portion of the membrane stack assembly; and wherein a second portion of the membrane stack assembly forms a multilayer membrane assembly disposed around the central core element; and wherein the feed carrier layer is in contact with the concentrate exhaust conduit and not in contact with the permeate exhaust conduit; and wherein the permeate carrier layer is in contact with the permeate exhaust conduit and not in contact with the concentrate exhaust conduit; and wherein the permeate carrier layer does not form an outer surface of the separator assembly.

### CROSS REFERENCE TO RELATED APPLICATIONS

This application claims the benefit of U.S. Provisional Applications No. 61/106,219, filed Oct. 17, 2008, and 61/111,366 filed Nov. 5, 2008 each of which is herein incorporated in its entirety by reference.

### BACKGROUND

This invention includes embodiments that generally relate to separator assemblies. In various embodiments, the invention relates to spiral flow separator assemblies. The invention also includes methods for making separator assemblies.

Conventional separator assemblies typically comprise a folded multilayer membrane assembly disposed around a porous exhaust conduit. The folded multilayer membrane assembly comprises a feed carrier layer in contact with the active-surface of a membrane layer having an active surface and a passive surface, and a permeate carrier layer in contact with the passive surface of the membrane layer and a porous exhaust conduit, the feed carrier layer, the membrane layer and the permeate carrier layer being folded to ensure contact between the layers and without bringing the feed carrier layer into contact with the permeate carrier layer or the porous exhaust conduit. During operation, a feed solution containing a solute is brought into contact with the feed carrier layer of the multilayer membrane assembly which transmits the feed solution to the active surface of the membrane layer which modifies and transmits a portion of the feed solution as a permeate to the permeate carrier layer. The feed solution also serves to disrupt solute accretion at the active surface of the membrane layer and transport excess solute out of the multilayer membrane assembly. The permeate passes via the permeate carrier layer into the porous exhaust conduit which collects the permeate. Separator assemblies comprising folded multilayer membrane assemblies have been used in various fluid purification processes, including reverse osmosis, ultrafiltration, and microfiltration processes.

Folded multilayer membrane assemblies may be manufactured by bringing the active surface of a membrane layer having an active surface and a passive surface into contact with both surfaces of a feed carrier layer, the membrane layer being folded to create a pocket-like structure which envelops the feed carrier layer. The passive surface of the membrane layer is brought into contact with one or more permeate carrier layers to produce a membrane stack assembly in which the folded membrane layer is disposed between the feed carrier layer and one or more permeate carrier layers. A plurality of such membrane stack assemblies, each in contact with at least one common permeate carrier layer, is then wound around a porous exhaust conduit in contact with the common permeate carrier layer to provide the separator assembly comprising the multilayer membrane assembly and the porous exhaust conduit. The edges of the membrane stack assemblies are appropriately sealed to prevent contact of the feed solution with the permeate carrier layer. Because conventional folded multilayer membrane assemblies are used in separator assemblies in which the feed solution passes through the assembly along the axis of the assembly (in a cross flow direction through the assembly) such folded multilayer membrane assemblies are especially susceptible to telescoping of the layered structure and consequent contamination of the permeate carrier layer. In addition, weaknesses in the membrane layer occasioned by its folding may result in loss of membrane function leading to uncontrolled contact between the feed solution and the permeate carrier layer.

Thus, there exists a need for further improvements in both the design and manufacture of separator assemblies comprising one or more multilayer membrane assemblies. Particularly in the realm of water purification for human consumption, there is a compelling need for more robust and reliable separator assemblies which are both efficient and cost effective.

### BRIEF DESCRIPTION

In one embodiment, the present invention provides a separator assembly comprising a membrane stack assembly comprising at least one feed carrier layer, at least one permeate carrier layer, and at least one membrane layer, the membrane layer being disposed between the feed carrier layer and the permeate carrier layer; and a central core element comprising at least one concentrate exhaust conduit and at least one permeate exhaust conduit; wherein the concentrate exhaust conduit and the permeate exhaust conduit are separated by a first portion of the membrane stack assembly; and wherein a second portion of the membrane stack assembly forms a multilayer membrane assembly disposed around the central core element; and wherein the feed carrier layer is in contact with the concentrate exhaust conduit and not in contact with the permeate exhaust conduit; and wherein the permeate carrier layer is in contact with the permeate exhaust conduit and not in contact with the concentrate exhaust conduit; and wherein the permeate carrier layer does not form an outer surface of the separator assembly.

In another embodiment, the present invention provides a salt separator assembly comprising a membrane stack assembly comprising at least one feed carrier layer, at least one permeate carrier layer, and at least one salt-rejecting membrane layer, the salt-rejecting membrane layer being disposed between the feed carrier layer and the permeate carrier layer; and a central core element comprising at least one concentrate exhaust conduit and at least one permeate exhaust conduit; wherein the concentrate exhaust conduit and the permeate exhaust conduit are separated by a first portion of the membrane stack assembly; and wherein a second portion of the membrane stack assembly forms a multilayer membrane assembly disposed around the central core element; and wherein the feed carrier layer is in contact with the concentrate exhaust conduit and not in contact with the permeate exhaust conduit; and wherein the permeate carrier layer is in contact with the permeate exhaust conduit and not in contact with the concentrate exhaust conduit; and wherein the permeate carrier layer does not form an outer surface of the salt separator assembly.

In yet another embodiment, the present invention provides a spiral flow reverse osmosis apparatus comprising (a) a pressurizable housing and (b) a separator assembly comprising a membrane stack assembly comprising at least one feed carrier layer, at least one permeate carrier layer, and at least one membrane layer, the membrane layer being disposed between the feed carrier layer and the permeate carrier layer; and a central core element comprising at least one concentrate exhaust conduit and at least one permeate exhaust conduit; wherein the concentrate exhaust conduit and the permeate exhaust conduit are separated by a first portion of the membrane stack assembly; and wherein a second portion of the membrane stack assembly forms a multilayer membrane assembly disposed around the central core element; and wherein the feed carrier layer is in contact with the concentrate exhaust conduit and not in contact with the permeate exhaust conduit; and wherein the permeate carrier layer is in contact with the permeate exhaust conduit and not in contact with the concentrate exhaust conduit; and wherein the permeate carrier layer does not form an outer surface of the separator assembly; and wherein the pressurizable housing comprises at least one feed inlet configured to provide a feed solution to the outer surface of the separator assembly; and wherein the pressurizable housing comprises at least one permeate exhaust outlet coupled to the permeate exhaust conduit, and at least one concentrate exhaust outlet coupled to the concentrate exhaust conduit.

In still yet another embodiment, the present invention provides a method for making a separator assembly, the method comprising providing a central core element comprising at least one concentrate exhaust conduit and at least one permeate exhaust conduit; disposing a first portion of a membrane stack assembly comprising at least one permeate carrier layer, at least one feed carrier layer, and at least one membrane layer within the central core element such that the concentrate exhaust conduit and permeate exhaust conduit are separated by the first portion of the membrane stack assembly; and radially disposing a second portion of the membrane stack assembly around the central core element, and sealing a resultant wound assembly to provide a separator assembly, wherein the concentrate exhaust conduit is not in contact with the permeate exhaust conduit, and wherein the feed carrier layer is in contact with the concentrate exhaust conduit and not in contact with the permeate exhaust conduit, and wherein the permeate carrier layer is in contact with the permeate exhaust conduit and not in contact with the concentrate exhaust conduit, and wherein the permeate carrier layer does not form an outer surface of the separator assembly.

These and other features, aspects, and advantages of the present invention may be understood more readily by reference to the following detailed description.

### BRIEF DESCRIPTION OF DRAWINGS

Various features, aspects, and advantages of the present invention will become better understood when the following detailed description is read with reference to the accompanying drawings in which like characters may represent like parts throughout the drawings.

FIG. 1 illustrates the components of a conventional separator assembly and method of its assembly.

FIG. 2 illustrates membrane stack assembly and a central core element configured in accordance with an embodiment of the present invention.

FIG. 3 illustrates a separator assembly in accordance with an embodiment of the present invention.

FIG. 4 illustrates a spiral flow reverse osmosis apparatus in accordance with an embodiment of the present invention.

FIG. 5 illustrates a method of making a separator assembly in accordance with an embodiment of the present invention.

FIG. 6 illustrates a separator assembly in accordance with an embodiment of the present invention.

FIG. 7 illustrates a central core element and central core element components in accordance with an embodiment of the present invention.

FIG. 8 illustrates a separator assembly in accordance with an embodiment of the present invention.

FIG. 9 illustrates a pressurizable housing used in accordance with an embodiment of the present invention.

FIG. 10 illustrates a central core element in accordance with an embodiment of the present invention.

FIG. 11 illustrates a central core element in accordance with an embodiment of the present invention.

### DETAILED DESCRIPTION

In the following specification and the claims, which follow, reference will be made to a number of terms, which shall be defined to have the following meanings.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As noted, in one embodiment, the present invention provides a separator assembly comprising a membrane stack assembly and a central core element. The membrane stack assembly comprises at least one feed carrier layer, at least one permeate carrier layer and at least one membrane layer wherein the membrane layer is disposed between the feed carrier layer and the permeate carrier layer. The central core element comprises at least one concentrate exhaust conduit and at least one permeate exhaust conduit. A first portion of the membrane stack assembly is disposed within the central core element and separates the concentrate exhaust conduit from the permeate exhaust conduit. The concentrate exhaust conduit and permeate exhaust conduit are said to be not in contact with each other. A second portion of the membrane stack assembly forms a multilayer membrane assembly disposed around the central core element. As the multilayer membrane assembly comprises a portion (the second portion) of the membrane stack assembly, it comprises the same elements as the membrane stack assembly, namely at least one feed carrier layer, at least one permeate carrier layer, and at least one membrane layer disposed between the feed carrier layer and the permeate carrier layer. The first portion of the membrane stack assembly is disposed within the central core element such that the feed carrier layer is in contact with the concentrate exhaust conduit and not in contact with the permeate exhaust conduit, and such that the permeate carrier layer is in contact with the permeate exhaust conduit and not in contact with the concentrate exhaust conduit. The second portion of the membrane stack assembly is disposed around the central core element to form a multilayer membrane assembly such that the feed carrier layer is not in contact with the permeate exhaust conduit, and such that the permeate carrier layer is not in contact with the concentrate exhaust conduit. In addition, the permeate carrier layer does not form an outer surface of the separator assembly.

As noted, the central core element comprises a concentrate exhaust conduit and a permeate exhaust conduit. The concentrate exhaust conduit is typically a porous tube running the length of the separator assembly, although other configurations may fall within the meaning of the term concentrate exhaust conduit, for example a longitudinally grooved structure, which structure may or may not be cylindrical, running the length of the separator assembly. Suitable porous tubes which may serve as the concentrate exhaust conduit include perforated metal tubes, perforated plastic tubes, perforated ceramic tubes and the like. In one embodiment, the concentrate exhaust conduit is not perforated but is sufficiently porous to allow passage of fluid from the feed carrier layer into the interior of the concentrate exhaust conduit. Fluid passing from the feed carrier layer into the concentrate exhaust conduit is at times herein referred to as a concentrate. In one embodiment, the concentrate exhaust conduit is a porous half-cylinder shaped tube. In an alternate embodiment, the concentrate exhaust conduit is a porous half-octagon shaped tube. In another embodiment, the concentrate exhaust conduit is a porous half-decahedron shaped tube. In yet another embodiment, the concentrate exhaust conduit is a porous half-tetradecahedron shaped tube. In one embodiment, the concentrate exhaust conduit is a porous teardrop shaped tube. The concentrate exhaust conduit may at each occurrence within a separator assembly have the same or different shapes. In one embodiment, the separator assembly comprises one or more concentrate exhaust conduits having a shape different from a permeate exhaust conduit present in the same separator assembly. In another embodiment, all of the concentrate exhaust conduits and permeate exhaust conduits present in a separator assembly have the same shape. In one embodiment, the concentrate exhaust conduit is a porous, modified half-cylinder shaped tube. As disclosed herein it is at times advantageous for the concentrate exhaust conduit and permeate exhaust conduit to comprise one or more spacer elements. The spacer elements in complimentary central core element components serve to create a cavity within the central core element in which the first portion of the membrane stack assembly may be disposed.

Similarly, the permeate exhaust conduit is typically a porous tube running the length of the separator assembly, although other configurations may fall within the meaning of the term permeate exhaust conduit, for example a longitudinally grooved structure, which structure may or may not be cylindrical, running the length of the separator assembly. Suitable porous tubes which may serve as the permeate exhaust conduit include perforated metal tubes, perforated plastic tubes, perforated ceramic tubes and the like. In one embodiment, the permeate exhaust conduit is not perforated but is sufficiently porous to allow passage of fluid from the permeate carrier layer into the interior of the permeate exhaust conduit. Fluid flowing through the permeate carrier layer is at times herein referred to as permeate. Similarly, fluid passing from the permeate carrier layer into the permeate exhaust conduit is at times herein referred to as permeate. In one embodiment, the permeate exhaust conduit is a porous half-cylinder shaped tube. In an alternate embodiment, the permeate exhaust conduit is a porous half-octagon shaped tube. In another embodiment, the permeate exhaust conduit is a porous half-decahedron shaped tube. In yet another embodiment, the permeate exhaust conduit is a porous half-tetradecahedron shaped tube. In one embodiment, the permeate exhaust conduit is a porous teardrop shaped tube. The permeate exhaust conduit may at each occurrence within a separator assembly have the same or different shapes. In one embodiment, the separator assembly comprises one or more permeate exhaust conduits having a shape different from a concentrate exhaust conduit present in the same separator assembly. In another embodiment, all of the permeate exhaust conduits and concentrate exhaust conduits present in a separator assembly have the same shape.

As used herein, the term “multilayer membrane assembly” refers to a second portion of the membrane stack assembly disposed around the central core element. The multilayer membrane assembly is thus a combination of at least one feed carrier layer, at least one permeate carrier layer, and at least one membrane layer disposed around a central core element comprising at least one concentrate exhaust conduit and at least one permeate exhaust conduit.

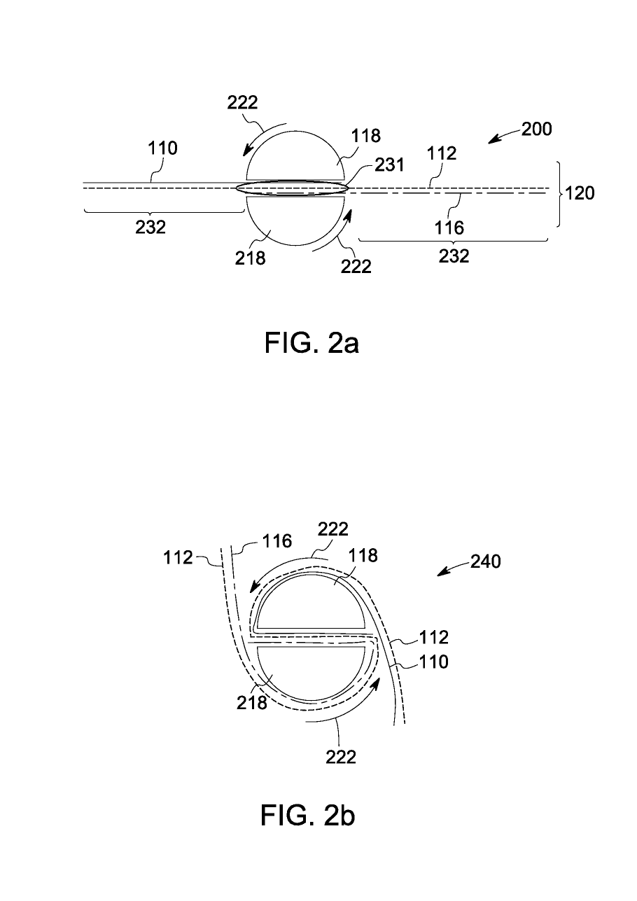

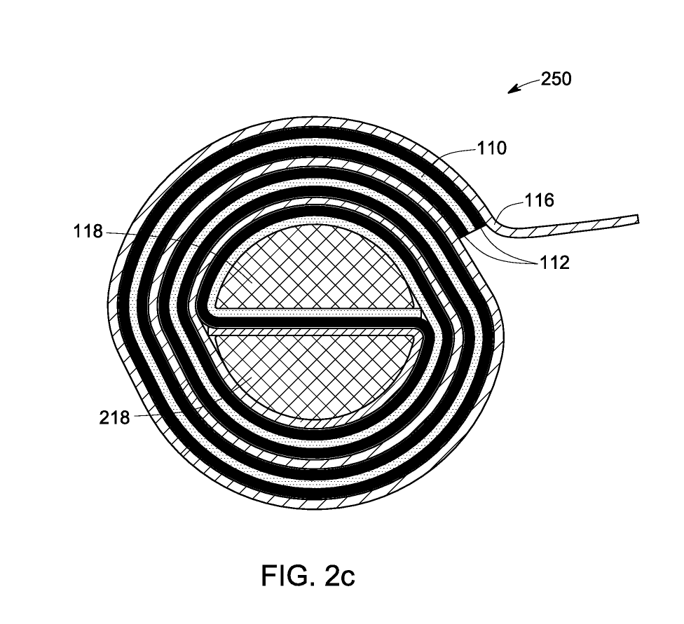

In one embodiment, the multilayer membrane assembly may be prepared by disposing a first portion of a membrane stack assembly within a central core element and then rotating the central core element, thereby winding a second portion of the membrane stack assembly around the central core element. As is disclosed in detail herein, the configuration of the membrane stack assembly and the disposing of the membrane stack assembly within the central core element are such that upon winding of the membrane stack assembly around the central core element to provide a wound structure (e.g. FIG. 2c) and securing of the free ends of the membrane stack assembly after winding, a separator assembly comprising a multilayer membrane assembly disposed around the central core element is obtained. Those skilled in the art will appreciate the close relationship, in certain embodiments, between the membrane stack assembly and the multilayer membrane assembly, and that the membrane stack assembly is the precursor of the multilayer membrane assembly. It is convenient to regard the membrane stack assembly as “unwound” and the multilayer membrane assembly as “wound”. It should be emphasized, however, that as defined herein a multilayer membrane assembly is not limited to the “wound” form of one or more membrane stack assemblies disposed within a central core element, as other means of disposing the second portion of the membrane stack assembly around the central core element may become available.

As noted, the membrane stack assembly and multilayer membrane assembly comprise at least one feed carrier layer. Materials suitable for use as the feed carrier layer include flexible sheet-like materials through which a feed solution may flow. In various embodiments of the present invention, the feed carrier layer is configured such that flow of a feed solution through the feed carrier layer occurs along a spiral path originating at the outer surface of the separator assembly and terminating at the concentrate exhaust conduit. The feed carrier layer may comprise structures which promote turbulent flow at the surface of the membrane layer in contact with the feed carrier layer as a means of preventing excessive solute build-up (accretion) at the membrane surface. In one embodiment, the feed carrier layer is comprised of a perforated plastic sheet. In another embodiment, the feed carrier layer is comprised of a perforated metal sheet. In yet another embodiment, the feed carrier layer comprises a porous composite material. In yet another embodiment, the feed carrier layer is a plastic fabric. In yet another embodiment, the feed carrier layer is a plastic screen. The feed carrier layer may be comprised of the same material as the permeate carrier layer or a material different from that used for the permeate carrier layer.

As noted, the membrane stack assembly and the multilayer membrane assembly comprise at least one permeate carrier layer. Materials suitable for use as the permeate carrier layer include flexible sheet-like materials through which a permeate may flow. In various embodiments of the present invention, the permeate carrier layer is configured such that during operation permeate flows in a spiral path along the permeate carrier layer to the permeate exhaust conduit. In one embodiment, the permeate carrier layer is comprised of a perforated plastic sheet. In another embodiment, the permeate carrier layer is comprised of a perforated metal sheet. In yet another embodiment, the permeate carrier layer comprises a porous composite. In yet another embodiment, the permeate carrier layer is a plastic fabric. In yet another embodiment, the permeate carrier layer is a plastic screen.

Membranes and materials suitable for use as the membrane layer are well-known in the art. U.S. Pat. No. 4,277,344, for example, discloses a semipermeable membrane prepared from the reaction of an aromatic polyamine with a polyacyl halide which has been found to be effective in reverse osmosis systems directed at rejecting sodium, magnesium and calcium cations, and chlorine, sulfate and carbonate anions. U.S. Pat. No. 4,277,344, for example, discloses a membrane prepared from the reaction of an aromatic polyacyl halide with a bifunctional aromatic amine to afford a polymeric material which has been found useful in the preparation of membrane layers effective in reverse osmosis systems directed at rejecting certain salts, such as nitrates. A host of technical references describing the preparation of various membranes and materials suitable for use as the membrane layer in various embodiments of the present invention are known to those of ordinary skill in the art. In addition, membranes suitable for use as the membrane layer in various embodiments of the present invention are well known and widely available articles of commerce.

In one embodiment, the membrane layer comprises a functionalized surface and an unfunctionalized surface. In one embodiment, the functionalized surface of the membrane layer represents an active surface of the membrane and the unfunctionalized surface of the membrane layer represents a passive surface of the membrane. In an alternate embodiment, the functionalized surface of the membrane layer represents a passive surface of the membrane and the unfunctionalized surface of the membrane layer represents an active surface of the membrane. In various embodiments of the present invention, the active surface of the membrane layer is typically in contact with the feed carrier layer and serves to prevent or retard the transmission of one or more solutes present in the feed solution across the membrane to the permeate carrier layer.

As used herein the phrase “not in contact” means not in “direct contact”. For example, two layers of the membrane stack assembly, or the multilayer membrane assembly, are not in contact when there is an intervening layer between them despite the fact that the two layers are in fluid communication, since in general fluid may pass from one layer to the other via the intervening layer. As used herein the phrase “in contact” means in “direct contact”. For example, adjacent layers in the membrane stack assembly, or the multilayer membrane assembly, are said to be “in contact”. Similarly a layer touching the surface of an exhaust conduit, as for example when a layer is wound around the exhaust conduit, is said to be “in contact” with the exhaust conduit provided that fluid may pass from the layer into the exhaust conduit. As a further illustration, the permeate carrier layer is said to be in contact with the permeate exhaust conduit when the permeate carrier layer is in direct contact with the permeate exhaust conduit, as for example when the permeate carrier layer is wound around the permeate exhaust conduit with no intervening layers between the surface of the permeate exhaust conduit and the permeate carrier layer. Similarly, the feed carrier layer is said to be not in contact with the permeate exhaust conduit, as when, for example, the permeate carrier layer is in direct contact with the permeate exhaust conduit and the permeate carrier layer is separated from the feed carrier layer by the membrane layer. In general, the feed carrier layer has no point of contact with the permeate exhaust conduit.

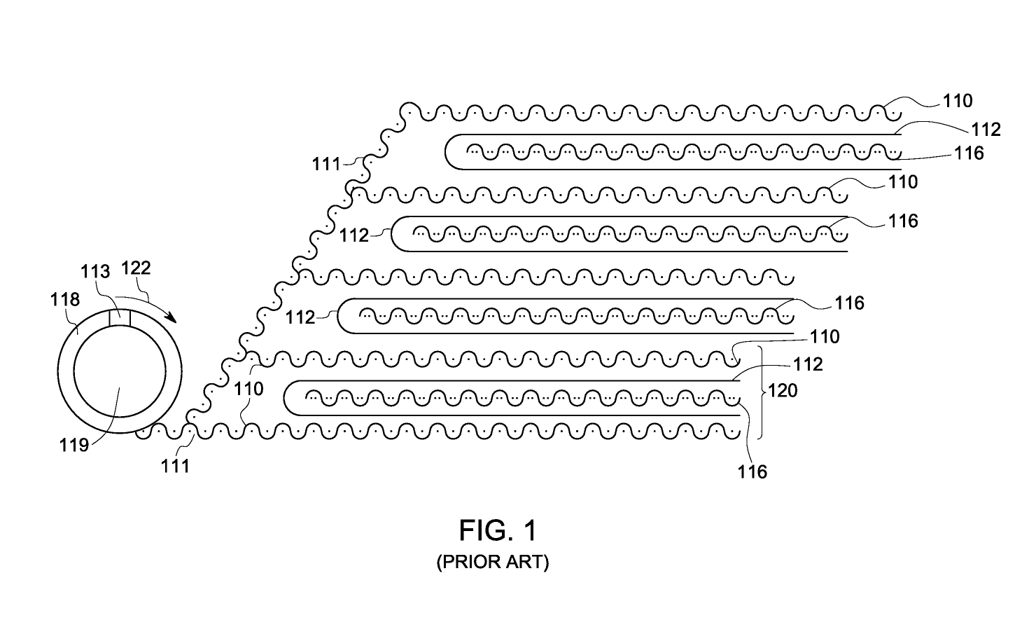

In one embodiment, the multilayer membrane assembly is radially disposed around the central core element. As used herein the phrase “radially disposed” means that the membrane layer, permeate carrier layer, and feed carrier layer are wound around a central core element comprising at least one concentrate exhaust conduit and at least one permeate exhaust conduit in a manner that limits the creation of folds or creases in the membrane layer. In general, the greater the extent to which a membrane layer is deformed by folding or creasing, the greater the likelihood of damage to the active surface of the membrane, loss of membrane function, and membrane integrity. Conventional separator assemblies typically comprise a highly folded multilayer membrane assembly comprising multiple folds in the membrane layer (e.g. FIG. 1). Assuming the unfolded membrane layer represents a 180 degree straight angle, a highly folded membrane layer can be described as having a fold characterized by a reflex angle of greater than about 340 degrees. In one embodiment, the separator assembly provided by the present invention contains no membrane layer folds characterized by a reflex angle greater than 340 degrees. In an alternate embodiment, the separator assembly provided by the present invention contains no membrane layer folds characterized by a reflex angle greater than 300 degrees. In yet another embodiment, the separator assembly provided by the present invention contains no membrane layer folds characterized by a reflex angle greater than 270 degrees.

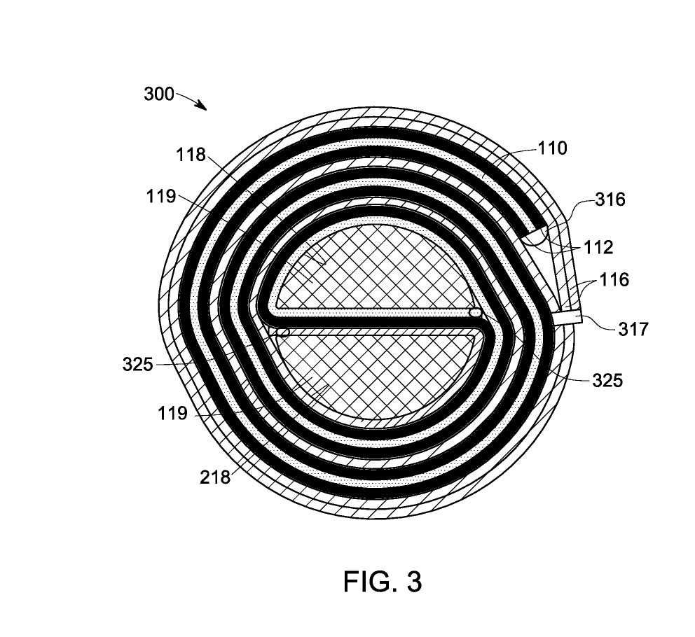

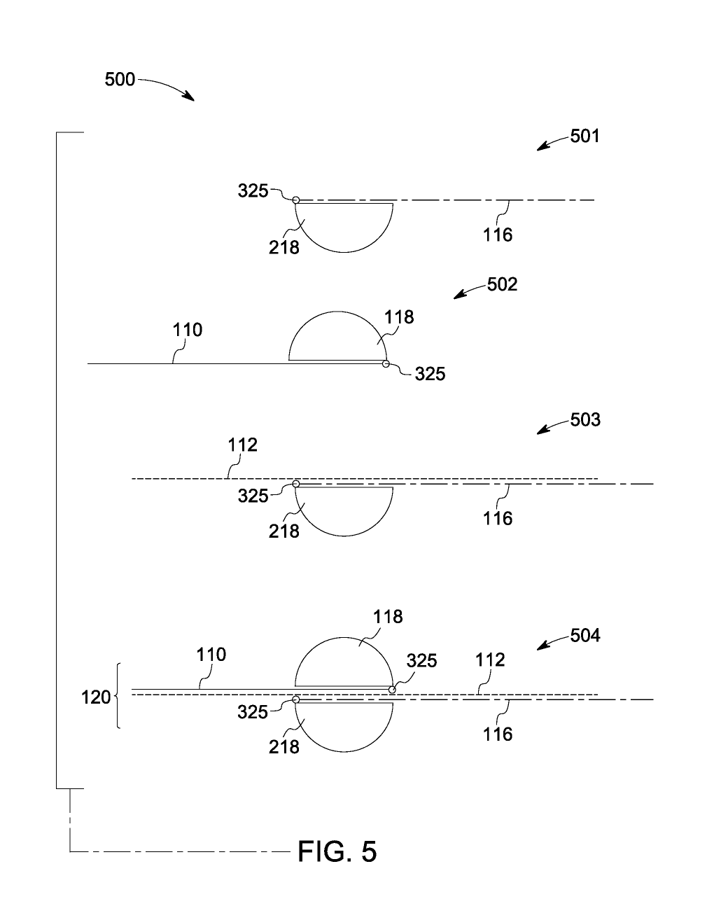

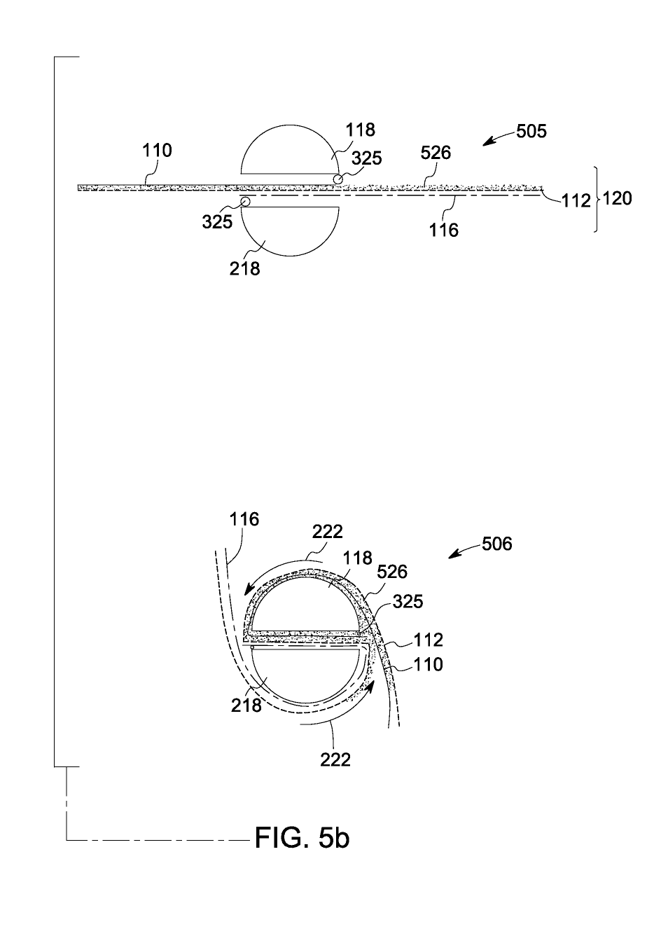

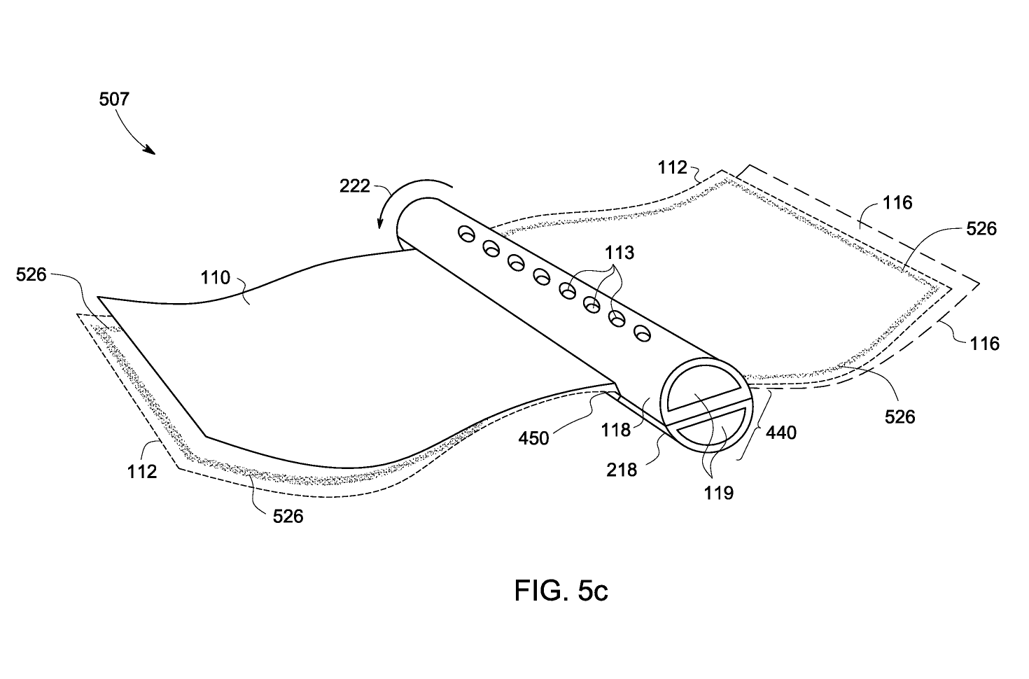

In one embodiment, the separator assembly provided by the present invention may be used as a salt separator assembly for separating salt from water. The feed solution may be, for example, seawater or brackish water. Typically the separator assembly is contained within a pressurizable housing which permits initial contact between the feed solution and the feed carrier layer only at outer surface of the separator assembly. This is typically accomplished by sealing the ends of the separator assembly within the pressurizable housing. For example a fully wound structure, as shown in for example FIG. 3, may be prepared and the exposed portions of the central core element may be masked. The ends of the fully wound structure are then dipped into a sealant, for example hot glue which is then cured. The result is a separator assembly in which the end surfaces are sealed with a barrier which does not transmit feed solution, permeate, or concentrate during operation. To illustrate this concept the separator assembly can be thought of as a cylinder having a first surface and a second surface each having a surface area of πr², wherein “r” is the radius of the cylinder defined by the separator assembly, and a third surface having a surface area of 2 πrh wherein “h” is the length of the cylinder. When the “ends” of the separator assembly 300 are sealed, each of the first surface and the second surface has been sealed to prevent contact of the feed solution with the feed carrier layer at any surface other than the third surface (also referred to at times herein as the “outer surface” and the “feed surface”) having surface area 2 πrh. In other embodiments, the separator assembly can by various means be made to fit snugly into a pressurizable housing such that a feed solution entering the pressurizable housing encounters only the third surface (the “feed surface”) of the separator assembly and neither permeate nor concentrate may exit the separator assembly via the first or second surfaces. In one embodiment, the feed solution enters the separator assembly at points on the third surface of the separator assembly where the feed carrier layer is in contact with the feed solution. As shown in FIG. 5 (FIG. 5c) the edges of the membrane stack assembly may be sealed to prevent contact and transmission of the feed solution by the permeate carrier layer. Thus, the feed solution enters the separator assembly at the “feed surface” (third surface) of the separator assembly and passes along a spiral path through the feed carrier layer of the separator assembly during which passage, the feed solution is modified by its contact with the membrane layer through which a portion of the feed solution (“permeate” or “the permeate”) passes and contacts the permeate carrier layer. The passage of the feed solution through the separator assembly is at times herein referred to as “spiral flow” through the separator assembly until it emerges as “concentrate” (also referred to at times as “brine”) at one or more concentrate exhaust conduits present in the separator assembly. One of ordinary skill in the art will appreciate that as a feed solution, for example seawater, travels from an initial point of contact between the feed solution and the feed carrier layer on the outer surface (“third surface”) of the separator assembly toward the concentrate exhaust conduit, the concentration of salt present in the fluid in the feed carrier layer is increased through the action of the salt-rejecting membrane layer in contact with the feed solution passing through the feed carrier layer, and that the concentrate reaching the concentrate exhaust conduit will be characterized by a higher concentration of salt than the seawater used as the feed solution.

The roles and function of the permeate exhaust conduit and permeate carrier layer may be illustrated using the salt separator assembly example above. Thus, in one embodiment, the separator assembly may be used as a salt separator assembly for separating salt from water. The feed solution, for example sea water, is contacted with the outer surface (the third surface) of the separator assembly comprised of a portion of the feed carrier layer remote from the concentrate exhaust conduit. The permeate carrier layer does not form an outer surface of the separator assembly and is not in direct contact with the feed solution. Under such circumstances, the permeate carrier layer is said not to form an outer surface of the separator assembly. As the feed solution passes along the feed carrier layer it contacts the salt-rejecting membrane layer which modifies and transmits a fluid comprising one or more components of the feed solution to the permeate carrier layer. This fluid transmitted by the salt-rejecting membrane layer, called permeate (or “the permeate”), passes along the permeate carrier layer until it reaches that portion of the permeate carrier layer in contact with the exterior of the permeate exhaust conduit, where the permeate is transmitted from the permeate carrier layer into the interior of the permeate exhaust conduit. One of ordinary skill in the art will appreciate that as a feed solution, is modified and transmitted by the salt-rejecting membrane layer into the permeate carrier layer, the concentration of salt in the permeate is reduced relative to the feed solution due to the salt rejecting action of the membrane layer.

In one embodiment, the separator assembly comprises a plurality of concentrate exhaust conduits. In one embodiment, the number of concentrate exhaust conduits is in a range of from 1 conduit to 8 conduits. In another embodiment, the number of concentrate exhaust conduits is in a range of from 2 conduits to 6 conduits. In still another embodiment, the number of concentrate exhaust conduits is in a range of from 3 conduits to 4 conduits.

In one embodiment, the separator assembly comprises a plurality of permeate exhaust conduits. In one embodiment, the number of permeate exhaust conduits is in a range of from 1 conduit to 8 conduits. In another embodiment, the number of permeate exhaust conduits is in a range of from 2 conduits to 6 conduits. In still another embodiment, the number of permeate exhaust conduits is in a range of from 3 conduits to 4 conduits.

In one embodiment, the separator assembly provided by the present invention comprises a single feed carrier layer. In an alternate embodiment, the separator assembly comprises a plurality of feed carrier layers. In one embodiment, the number of feed carrier layers is in a range of from 1 layer to 6 layers. In another embodiment, the number of feed carrier layers is in a range of from 2 layers to 5 layers. In still another embodiment, the number of feed carrier layers is in a range of from 3 layers to 4 layers.

In one embodiment, the separator assembly provided by the present invention comprises a single permeate carrier layer. In an alternate embodiment, the separator assembly comprises a plurality of permeate carrier layers. In one embodiment, the number of permeate carrier layers is in a range of from 1 layer to 6 layers. In another embodiment, the number of permeate carrier layers is in a range of from 2 layers to 5 layers. In still another embodiment, the number of permeate carrier layers is in a range of from 3 layers to 4 layers.

In one embodiment, the separator assembly provided by the present invention comprises a single membrane layer. In an alternate embodiment, the separator assembly comprises a plurality of membrane layers. In one embodiment, the number of membrane layers is in a range of from 1 layer to 6 layers. In another embodiment, the number of membrane layers is in a range of from 2 layers to 5 layers. In still another embodiment, the number of membrane layers is in a range of from 3 layers to 4 layers. In one embodiment, the number of membrane layers is directly proportional to the active surface area required to be provided by the separator assembly.

Referring to FIG. 1, the figure represents the components of and method of preparing a conventional separator assembly. In conventional separator assemblies, a membrane stack assembly 120 comprises a folded membrane layer 112 wherein a feed carrier layer 116 is sandwiched between the two halves of the folded membrane layer 112. The folded membrane layer 112 is disposed such that an active surface (not shown in figure) of the folded membrane layer is in contact with the feed carrier layer 116. The folded membrane layer 112 is enveloped by permeate carrier layers 110 such that the passive surface (not shown in figure) of the membrane layer 112 is in contact with the permeate carrier layers 110. Typically, an adhesive sealant (not shown) is used to isolate the feed carrier layer from the permeate carrier layer and prevent direct contact between a feed solution (not shown) and the permeate carrier layer. A plurality of membrane stack assemblies 120 wherein each of the permeate layers 110 is connected to a common permeate carrier layer 111 in contact with the permeate exhaust conduit 118 is wound around the permeate exhaust conduit 118, for example by rotating the permeate exhaust conduit 118 in direction 122, and the resultant wound structure is appropriately sealed to provide a conventional separator assembly. The permeate exhaust conduit comprises openings 113 to permit fluid communication with the common permeate carrier layer 111. As the membrane stack assemblies are wound around the permeate exhaust conduit 118, the reflex angle defined by the folded membrane layer 112 approaches 360 degrees.

Referring to FIG. 2, FIG. 2a represents cross-section view at midpoint 200 of a first portion 231 of a membrane stack assembly 120 disposed within a central core element comprising a permeate exhaust conduit 118 and a concentrate exhaust conduit 218. A second portion 232 of the membrane stack assembly 120 is disposed outside of the central core element in accordance with an embodiment of the present invention. The first portion of membrane stack assembly separates the permeate exhaust conduit 118 from the concentrate exhaust conduit 218. The membrane stack assembly 120 comprises a permeate carrier layer 110, a membrane layer 112, and a feed carrier layer 116. Rotation of the central core element in direction 222 affords the partially wound structure 240 shown in FIG. 2b in accordance with an embodiment of the present invention. That portion (the second portion 232) of the membrane stack assembly 120 which is wound around the central core element becomes the multilayer membrane assembly of the completed separator assembly. FIG. 2c shows the wound structure 250 obtained after the permeate carrier layer 110 and membrane layer 112 have been completely wound around the central core element and sufficient feed carrier layer 116 remains to prepare the separator assembly 300 shown in FIG. 3. The separator assembly 300 (FIG. 3) is obtained by completely winding the second portion of the membrane stack assembly around the central core element and securing the ends of the membrane stack assembly. In addition the ends of the wound structure are sealed to prevent edge-on contact of the feed solution with the separator assembly.

Referring to FIG. 3, the figure represents a cross-section view at midpoint of a separator assembly 300 in accordance with an embodiment of the present invention. Separator assembly 300 comprises a central core element comprising a permeate exhaust conduit 118 and a concentrate exhaust conduit 218, each exhaust conduit defining an interior channel 119. Separator assembly 300 comprises a membrane stack assembly 120 (FIG. 2) comprising a feed carrier layer 116, a permeate carrier layer 110, and a membrane layer 112, the membrane layer 112 being disposed between the feed carrier layer 116 and the permeate carrier layer 110. The permeate exhaust conduit 118 and the concentrate exhaust conduit 218 of the central core element are separated by a first portion 231 (FIG. 2a) of the membrane stack assembly. A second portion 232 (FIG. 2a) of the membrane stack assembly forms a multilayer membrane assembly disposed around the central core element. FIG. 3 shows clearly that the feed carrier layer 116 is not in contact with the permeate exhaust conduit 118 or the permeate carrier layer 110, and that the permeate carrier layer 110 is not in contact with the concentrate exhaust conduit 218 or the feed carrier layer 116. The ends of membrane stack assembly 120 are secured with sealing portion 316. Sealing portion 316 is a transverse line of sealant (typically a curable glue) which seals the outermost permeate carrier layer to the two adjacent membrane layers 112, said transverse line running the length of the separator assembly 300. Typically the sealant is applied to the passive surface of the membrane layer 112 which when contacted with the adjacent permeate carrier layer, the sealant penetrates and seals the edge of permeate carrier layer. The sealant does not typically penetrate through the active surface of the membrane layer and thus does not come into contact with either the active surface (not shown) of the membrane layer 112 or the feed carrier layer 116. The “third surface” of the separator assembly 300 illustrated in FIG. 3 is comprised exclusively of the feed carrier layer 116 which envelops the underlying wound structure. Also featured in the separator assembly 300 illustrated in FIG. 3 are adhesive lines 325 which secure the innermost ends of the permeate carrier layer 110 and the feed carrier layer 116 to the permeate exhaust conduit 118 and concentrate exhaust conduit 218 respectively. A variety of adhesive sealants, such as glues and/or double-sided tapes may be used to secure the ends of the multilayer membrane assembly to one another (sealing portion 316), the permeate carrier layer and feed carrier layer to the permeate exhaust conduit and concentrate exhaust conduit (transverse sealant line 325), and the end feed carrier layer to itself (sealing portion 317) on the outer surface of the separator assembly. (See also FIG. 5c, in which edge sealant 526 applied to the passive surface of the membrane layer seals the separator assembly at the permeate carrier layer-membrane layer interfaces). Any gaps present within a separator assembly may be eliminated by filling the gap with gap sealant. Gap sealants include curable sealants, adhesive sealants, and the like.

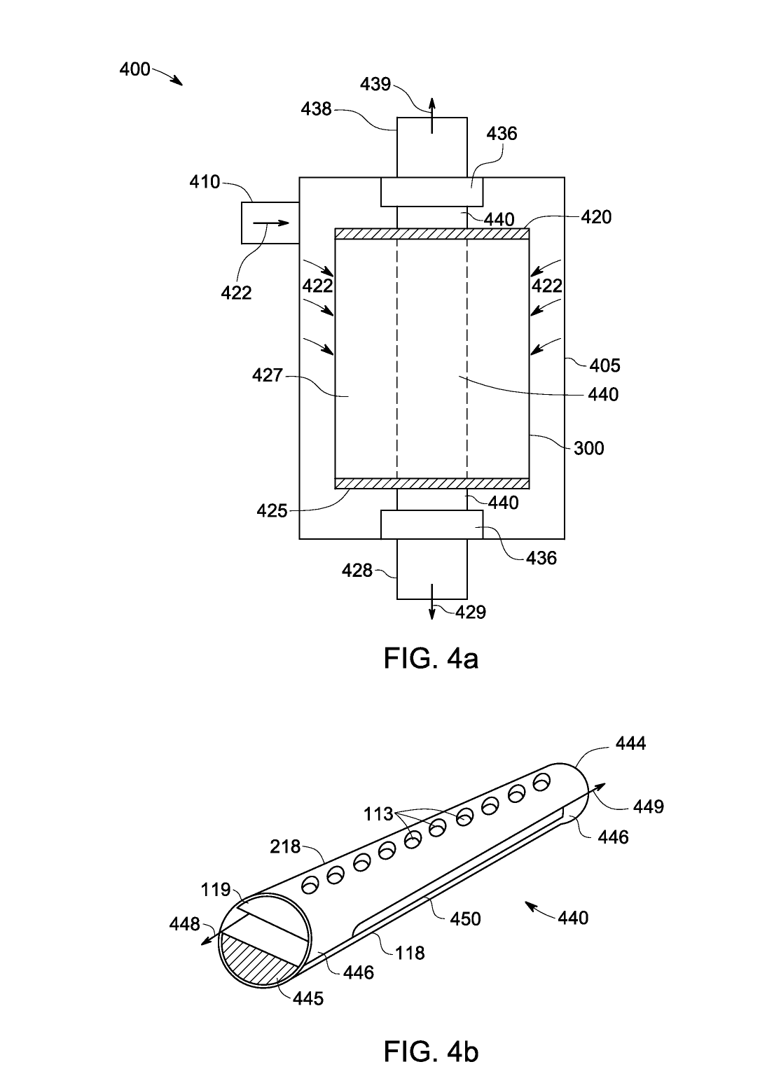

Referring to FIG. 4, the FIG. 4a represents side-on view of a spiral flow reverse osmosis apparatus 400 in accordance with an embodiment of the present invention. The spiral flow reverse osmosis apparatus 400 comprises a separator assembly 300 secured by coupling members 436 within a pressurizable housing 405. The pressurizable housing 405 comprises a feed inlet 410 configured to provide a feed solution to the outer surface 427 of the separator assembly 300. The pressurizable housing 405 further comprises a permeate exhaust outlet 438 coupled to the permeate exhaust conduit 118 (not shown) of the separator assembly 300, and a concentrate exhaust outlet 428 coupled to the concentrate exhaust conduit 218 (not shown) of separator assembly 300. The ends of central core element 440 are inserted into coupling members 436 to connect the permeate exhaust conduit 118 and the concentrate exhaust conduit 218 to the permeate exhaust outlet 438 and concentrate exhaust outlet 428 respectively. Directional arrows 422 indicate the direction of contact of a feed solution (not shown) with the outer surface 427 of the separator assembly. Direction arrows 429 and 439 indicate the direction of flow of concentrate and permeate respectively through the concentrate exhaust outlet 428 and permeate exhaust outlet 438. FIG. 4a further illustrates the sealed first surface 420 and sealed second surface 425 which prevent the introduction of feed solution into the separator assembly through surfaces other than outer surface 427. FIG. 4b illustrates the central core element 440 present in the separator assembly 300 depicted in FIG. 4a. The central core element comprises a permeate exhaust conduit 118 and a concentrate exhaust conduit 218 each of which is blocked at ends 445 and 444 respectively. Permeate exiting the permeate exhaust conduit 118 flows in direction 449 while concentrate exiting the concentrate exhaust conduit 218 flows in direction 448. Within the permeate exhaust conduit and concentrate exhaust conduit shown in FIG. 4b, flow is said to be unidirectional. In the embodiment shown in FIG. 4b the central core element is a separable pair of half cylinders 118 and 218 modified by the presence of spacer elements 446. In the embodiment illustrated in FIG. 4b, each of the permeate exhaust conduit 118 and concentrate exhaust conduit 218 are identical. Permeate exhaust conduit 118 comprises spacer element 446 and openings 113 (not shown) communicating with channel 119 (not shown). Permeate exhaust conduit 118 is blocked at end 445. Concentrate exhaust conduit 218 comprises spacer element 446 and openings 113 communicating with channel 119. Concentrate exhaust conduit 218 is blocked at end 444. Spacer elements 446 define a cavity 450 which accommodates a first portion of the membrane stack assembly 120 (See FIG. 2a).

Referring to FIG. 5, the figure represents a method 500 in accordance with an embodiment of the present invention for making the separator assembly 300 shown in FIG. 3. In a first method step 501 a first intermediate assembly is formed by providing a concentrate exhaust conduit 218 and applying a bead of glue (not shown) along a line 325 running a length of the concentrate exhaust conduit and thereafter placing the feed carrier layer 116 in contact with the uncured glue along line 325 and curing to provide the first intermediate assembly shown.

The portion of the concentrate exhaust conduit referred to as “a length of the concentrate exhaust conduit” corresponds to the width of the feed carrier layer and to that portion of the concentrate exhaust conduit adapted for contact with the feed carrier layer. As is apparent from this example and other parts of this disclosure, the length of the concentrate exhaust conduit is typically greater than the length of that portion of the concentrate exhaust conduit adapted for contact with the feed carrier layer. And typically, the concentrate exhaust conduit is longer than the multilayer membrane assembly disposed around it in the separator assembly provided by the present invention. That portion of the concentrate exhaust conduit adapted for contact with the feed carrier layer is porous, for example by being provided with openings, for example those shown as elements 113 in FIG. 4b. In typical embodiments of the present invention, that portion of the concentrate exhaust conduit not adapted for contact with the feed carrier layer is not porous.

In a second method step 502 a second intermediate assembly is formed by providing a permeate exhaust conduit 118 and applying a bead of glue (not shown) along a line 325 running a length of the permeate exhaust conduit and thereafter placing the permeate carrier layer 110 in contact with the uncured glue along line 325 and curing to provide the second intermediate assembly shown.

The portion of the permeate exhaust conduit referred to as “a length of the permeate exhaust conduit” corresponds to the width of the permeate carrier layer and to that portion of the permeate exhaust conduit adapted for contact with the permeate carrier layer. As is apparent from this example and other parts of this disclosure, the length of the permeate exhaust conduit is typically greater than the length of that portion of the permeate exhaust conduit adapted for contact with the permeate carrier layer. And typically, the permeate exhaust conduit is longer than the multilayer membrane assembly disposed around it in the separator assembly provided by the present invention. That portion of the permeate exhaust conduit adapted for contact with the permeate carrier layer is porous, for example by being provided with openings, for example those shown as elements 113 in FIG. 4b. In typical embodiments of the present invention that portion of the permeate exhaust conduit not adapted for contact with the permeate carrier layer is not porous.

In a third method step 503, a third intermediate assembly is prepared. A membrane layer 112 having an active surface (not shown) and a passive surface (not shown) is placed in contact with the first intermediate assembly of method step 501 such that the active surface (not shown) of the membrane layer 112 is in contact with the feed carrier layer 116. The membrane layer 112 is positioned such that it is bisected by, but not in contact with, concentrate exhaust conduit 218.

In a fourth method step 504, a fourth intermediate assembly is formed. A second intermediate assembly as depicted in method step 502 is joined to the third intermediate assembly depicted in method step 503. The fourth intermediate assembly depicted in method step 504 features a membrane stack assembly 120 comprising a membrane layer 112 disposed between a feed carrier layer 116 and a permeate carrier layer 110. The fourth intermediate assembly shown in method step 504 shows a first portion of membrane stack assembly 120 disposed within a central core element comprising a permeate exhaust conduit 118 and a concentrate exhaust conduit 218, and a second portion of membrane stack assembly 120 disposed outside of the central core element.

In a fifth method step 505 (FIG. 5b) an edge sealant 526 is applied as a longitudinal line along each edge of the passive surface of the membrane layer 112 to afford a fifth intermediate assembly. The edge sealant permeates the adjacent permeate carrier layer along the entire length of its edge. Those skilled in the art will appreciate that the fifth intermediate assembly represented in method step 505 (FIG. 5b) does not represent a cross-section at midpoint view but is, rather, a view from the incipient first or second surface of the separator assembly.

In a sixth method step 506 the free portions of the fifth intermediate assembly (also referred to as the “second portion” of the membrane stack assembly) are wound around the central core element before curing of the edge sealant 526. Winding the second portion of the membrane stack assembly around the central core element is carried out while the edge sealant is in an uncured state to allow the surfaces of layers of the membrane stack assembly some freedom of motion during the winding process. In one embodiment, the edge sealant 526 is applied as part of the winding step. The structure shown in method step 506 (a sixth intermediate assembly) depicts the structure shown in method step 505 after rotating the central core element through about 180 degrees. The preparation of separator assembly 300 may be completed by rotating the central core element in direction 222 thereby winding the second portion of the membrane stack assembly around the central core element to form a wound structure, and then securing the ends of the membrane stack assembly. The length of the feed carrier layer is sufficiently long so that it envelops the underlying wound structure and comprises the entire outer surface (third surface) of the separator assembly. The first and second surfaces of the separator assembly are sealed to prevent edge-on contact of feed solution with the feed carrier layer. The ends of the membrane stack assembly present in the wound structure may be secured by various means such as curable adhesives, curable glues, double sided tapes and the like. The wound second portion of the membrane stack assembly is referred to in this embodiment as the multilayer membrane assembly. This multilayer membrane assembly is said to be disposed around the central core element comprising permeate exhaust conduit 118 and concentrate exhaust conduit 218. Curing of edge sealant 526, effectively seals the edges of the permeate carrier layer 110 and membrane layer 112 at both the first and second surfaces of the separator assembly, and blocks fluid transmission from the feed surface except by means of the feed carrier layer 116.

Referring to FIG. 5c, structure 507 presents a perspective view of a membrane stack assembly 120 disposed within a central core element 440 during the preparation of a separator assembly of the present invention. The structure 507 corresponds to the fifth intermediate assembly shown in method step 505. A curable edge sealant 526 is shown as disposed along each longitudinal and transverse edge (there are a total of six such edges) on the passive surface of membrane layer 112 and in contact with permeate carrier layer 110. The central core element 440 is rotated in direction 222 to provide a wound structure.

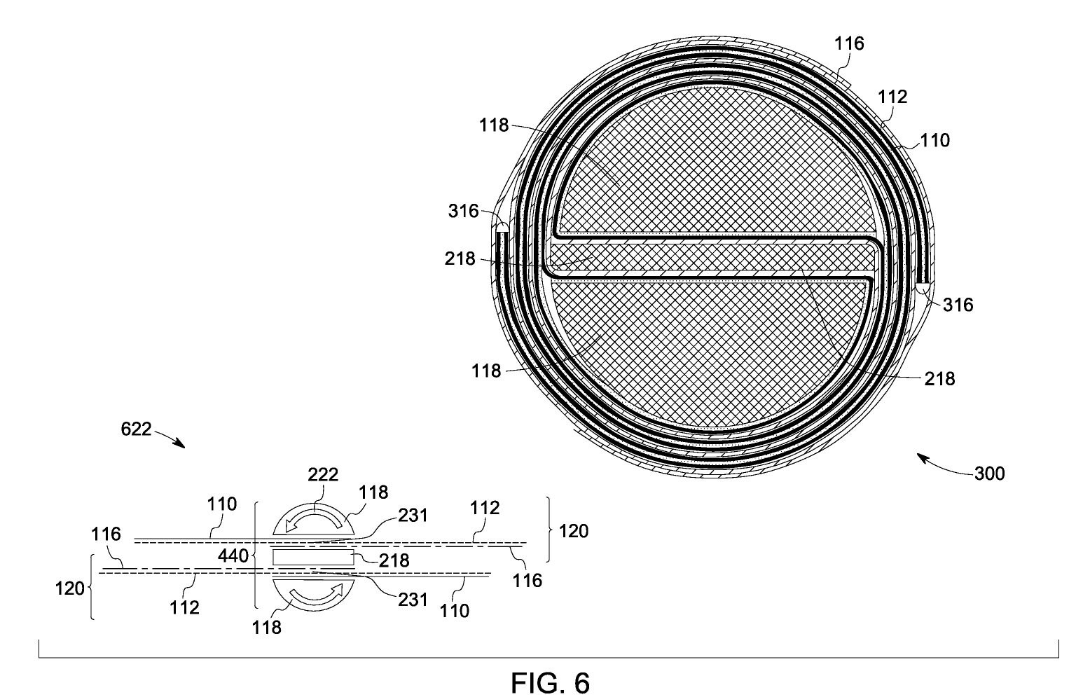

Referring to FIG. 6, the figure represents a cross-section view at midpoint of a separator assembly 300 in accordance with an embodiment of the present invention. The separator assembly 300 comprises two permeate carrier layers 110, two membrane layers 112, and two feed carrier layers 116 radially disposed around a central core element comprising two permeate exhaust conduits 118 and a concentrate exhaust conduit 218. The permeate exhaust conduits 118 and the concentrate exhaust conduit 218 are not in contact with each other. The outer surface of the separator assembly 300 is comprised of the feed carrier layers 116 which completely envelop the underlying wound structure. The ends of the feed carrier layers 116 are secured by additional sealing portions (not shown). Separator assembly 300 may be prepared by providing two membrane stack assemblies 120 disposed as shown in 622 (FIG. 6) within a central core element 440 comprising two permeate exhaust conduits 118 and one concentrate exhaust conduit 218. The two membrane stack assemblies 120 are then wound about the central core element in direction 222 to provide a multilayer membrane assembly radially disposed around central core element 440. The preparation of the separator assembly 300 is completed by applying sealing portions 316 and securing the ends of feed carrier layers 116, for example by gluing. Sealing portions 316 prevent direct contact of a feed solution with the permeate carrier layer. The first and second surfaces (not shown) of the separator assembly 300 depicted in FIG. 6 may be sealed by, for example, masking the ends of the concentrate exhaust conduit 218 and permeate exhaust conduits 118 and dipping the ends of the wound assembly in epoxy sealant followed by curing. The ends of the permeate exhaust conduit and concentrate exhaust conduit are unmasked to provide the completed separator assembly 300.

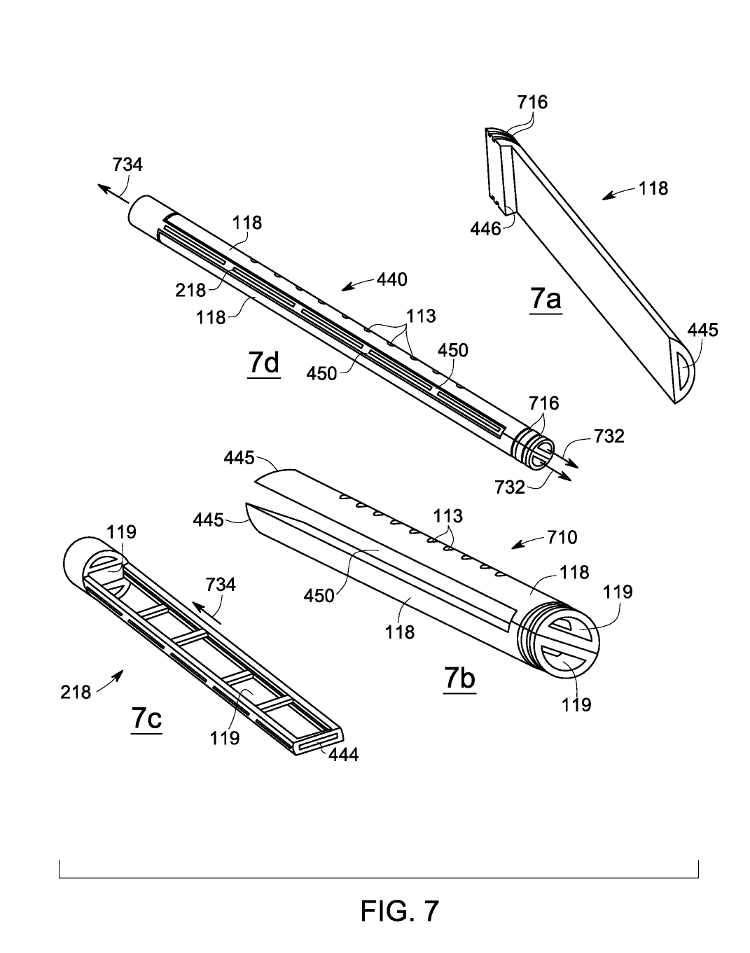

Referring to FIG. 7, the FIG. 7d represents a central core element 440 which may be employed in various embodiments of the present invention. Central core element 440 comprises two permeate exhaust conduits 118 and a concentrate exhaust conduit 218. In the example presented by FIG. 7, the central core element 440 may be used to prepare separator assembly 300 shown in FIG. 6 in cross-section view at midpoint. Each of the permeate exhaust conduits 118 present in central core element 440, is shown in FIG. 7a as a modified half cylinder comprising a permeate exhaust channel 119 (not visible in FIG. 7a but shown in FIG. 7b), openings 113 (not shown) communicating with permeate exhaust channel 119, spacer element 446, and grooves 716 adapted for securing an o-ring. The channel 119 runs the length of permeate exhaust conduit 118 which in this example is open one end and closed at end 445. Two permeate exhaust conduits 118 are joined to form partial structure 710 (FIG. 7b) in which openings 113 are visible. Openings 113 allow permeate to flow from the permeate carrier layer into the permeate exhaust channel 119. Partial structure 710 further defines a cavity 450 which accommodates both the concentrate exhaust conduit 218 and two membrane stack assemblies 120 (configured as shown in FIG. 6 (structure 622)). The concentrate exhaust conduit 218 (FIG. 7c) comprises a concentrate exhaust channel 119 which is closed at end 444. As noted, concentrate exhaust conduit 218 is closed at end 444 and flow through the exhaust channel 119 of the concentrate exhaust conduit is restricted to direction 734 (See FIGS. 7c and 7d). Referring to the cross-section view of separator assembly 300 (FIG. 6), the figure shows permeate exhaust conduits 118 are not in contact with concentrate exhaust conduit 218 and that the feed carrier layer 116 is not in contact with the permeate carrier layer 110 or the permeate exhaust conduits 118, and that the feed carrier layer forms the outer surface of the separator assembly 300.

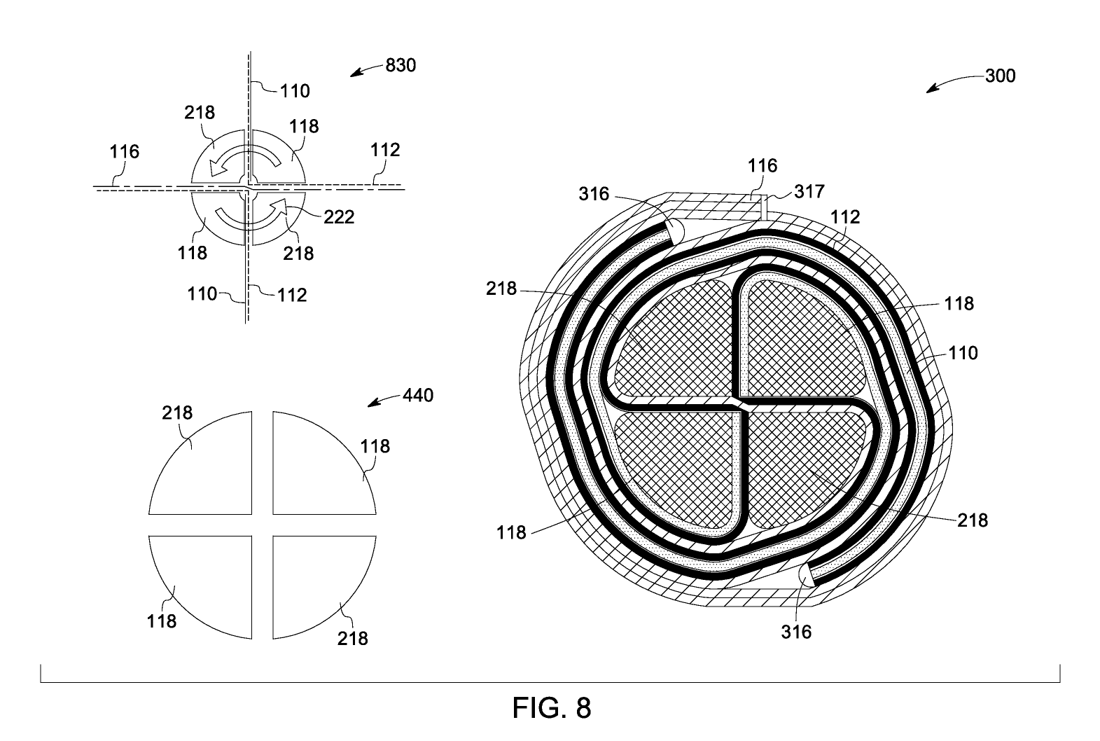

Referring to FIG. 8, the figure represents a separator assembly 300 in accordance with an embodiment of the present invention. The separator assembly 300 shown in cross-section view at midpoint, comprises two permeate carrier layers 110, two membrane layers 112, and a single feed carrier layer 116 radially disposed around a central core element 440 comprising two permeate exhaust conduits 118, and two concentrate exhaust conduits 218. Sealing portions 316 prevent direct contact of a feed solution with the permeate carrier layer 110, and sealing portion 317 secures the outer ends of the feed carrier layer 116. The permeate exhaust conduits 118 and the concentrate exhaust conduits 218 are not in contact with each other. Separator assembly 300 may be prepared as shown in 830 (FIG. 8) by disposing a single feed carrier layer 116, two permeate carrier layers 110 and two membrane layers 112 within a central core element 440 comprising two permeate exhaust conduits 118 and two concentrate exhaust conduits 218. As shown in the FIG. 8 (830), each of the two permeate carrier layers 110 is configured to be in contact with one of the two permeate exhaust conduits 118, and further, the length of the portion of the permeate carrier layer disposed within the central core element is about one half the diameter of the central core element 440. The membrane layers 112 are disposed within the central core element 440 as shown in 830. The approximately 90 degree bend in membrane layers 112 corresponds to a reflex angle of approximately 270 degrees. The feed carrier layer 116 bisects the central core element 440 and is the only layer among the permeate carrier layer, membrane layer and permeate carrier layer to do so. The layers are wound around the central core element 440 in direction 222 to provide a multilayer membrane assembly radially disposed around the central core element. The preparation of the separator assembly 300 is completed by applying sealing portions 316 and securing with sealing portion 317 the end of feed carrier layer 116, for example by gluing the end of feed carrier layer to itself. The ends of the wound assembly are sealed to prevent edge-on contact of a feed solution with the first or second surfaces of separator assembly.

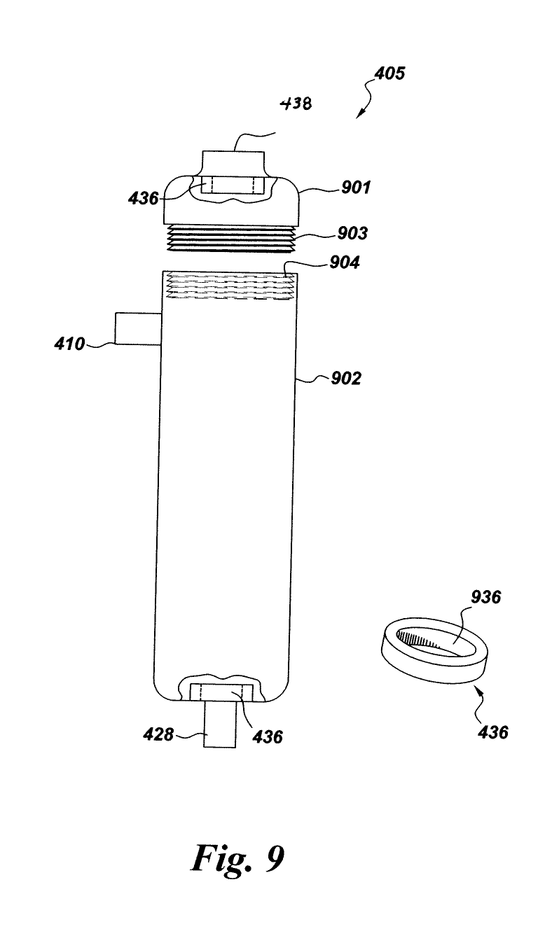

Referring to FIG. 9, the figure represents a pressurizable housing 405 used in accordance with an embodiment of the present invention for making a spiral flow reverse osmosis apparatus, for example the spiral flow reverse osmosis apparatus 400 shown in FIG. 4a. Referring to FIG. 9, pressurizable housing 405 comprises a detachable first portion 901 and a detachable second portion 902. The first and second portions 901 and 902 may be joined by means of threads 903 for securing 901 to 902, and threads 904 which are complimentary to threads 903. Other means of securing a detachable first portion of the pressurizable housing to a detachable second portion of the pressurizable housing include the use of snap together elements, gluing, taping, clamping and like means. Coupling members 436 secure the separator assembly 300 within the pressurizable housing 405 and define a cavity 936 into which the ends of the central core element 440 are inserted.

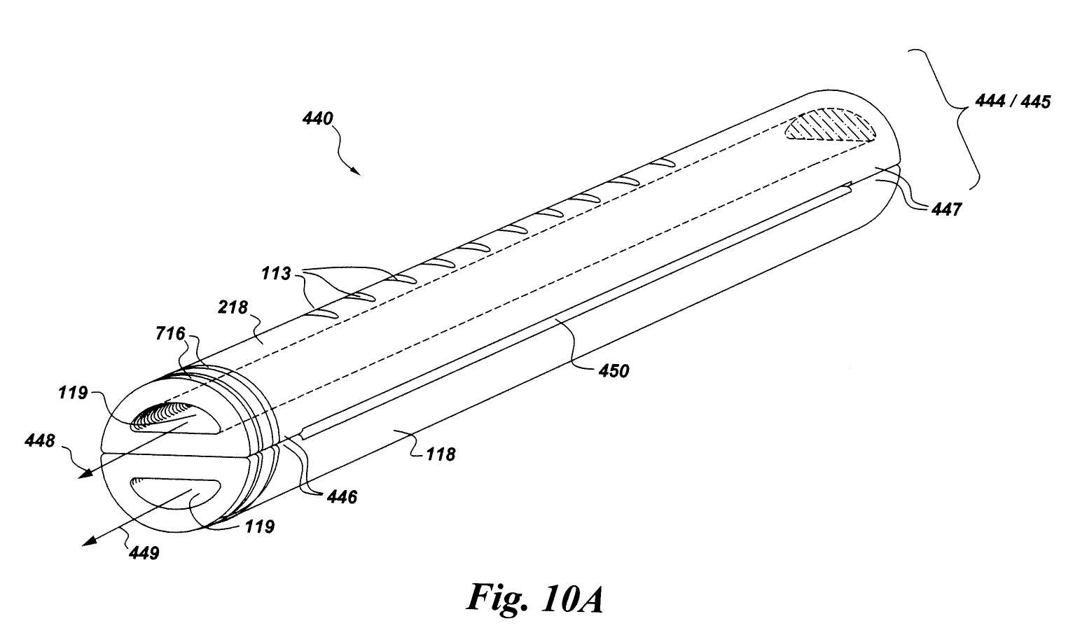

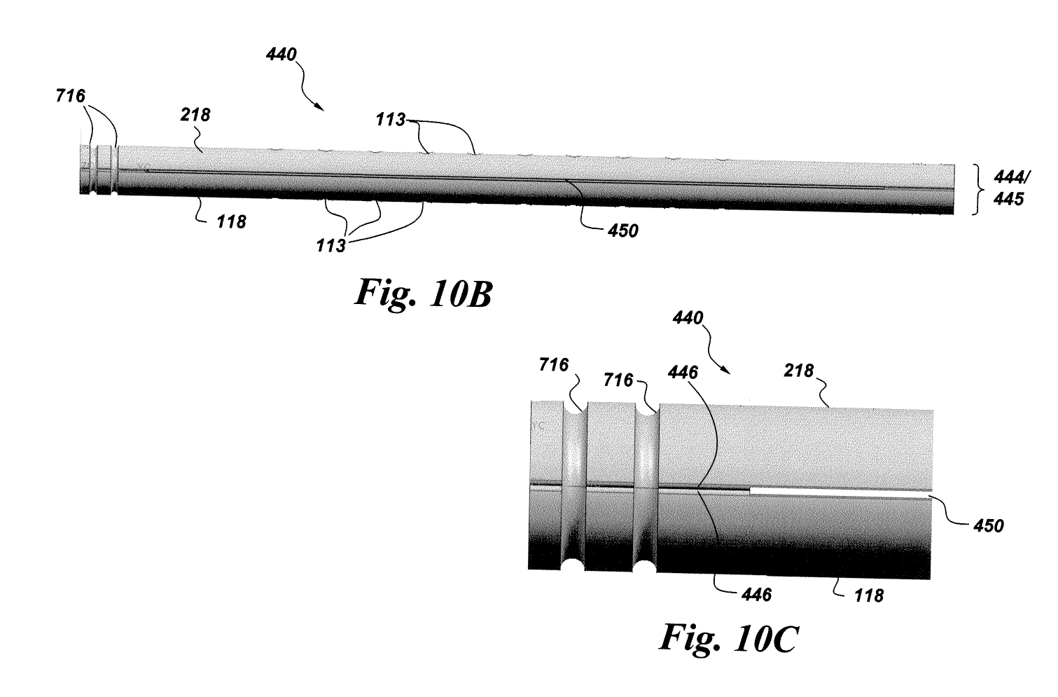

Referring to FIG. 10, FIG. 10a represents a three dimensional view of a central core element 440 used in accordance with an embodiment of the present invention. The central core element 440 comprises a concentrate exhaust conduit 218 and a permeate exhaust conduit 118 each of which is blocked at ends 444 and 445 respectively. Thus, during operation of a separator assembly comprising central core element 440, flow through concentrate exhaust conduit 218 is unidirectional in direction 448, and flow through permeate exhaust conduit 118 is unidirectional in direction 449. Each of the permeate and concentrate exhaust conduits defines a channel 119 and openings 113. At one end, the central core element 440 comprises grooves 716 adapted for securing an o-ring. The component permeate exhaust conduit 118 and concentrate exhaust conduit 218 each comprise spacer elements 446 and 447 which define cavity 450 which may accommodate the first portion of a membrane stack assembly.

Still referring to FIG. 10, FIG. 10b represents a three dimensional solid view of a central core element 440 of the present invention. As in FIG. 10a, the permeate exhaust conduit is blocked at end 445, and the concentrate exhaust conduit is blocked at end 444.

Still referring to FIG. 10, FIG. 10c represents an expanded three dimensional solid view of a portion of the central core element 440 of the present invention shown in FIG. 10b.

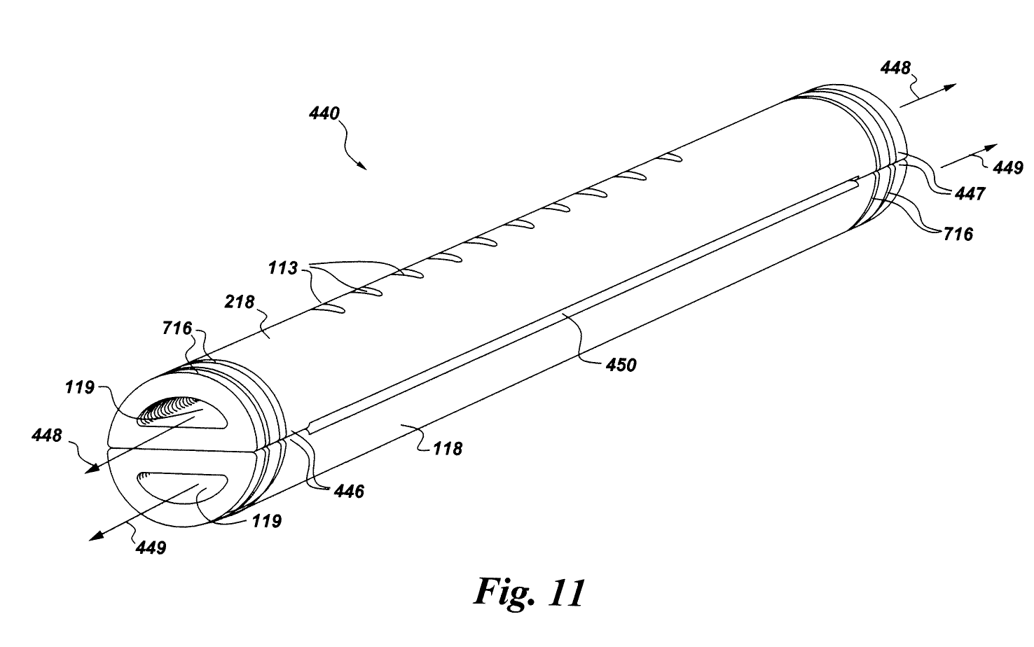

Referring to FIG. 11, the figure represents an alternate embodiment of a central core element 440 in accordance with the present invention. The central core element 440 illustrated in FIG. 11 comprises a permeate exhaust conduit 118 and concentrate exhaust conduit 218 each of which is open at both ends. Each exhaust conduit defines a channel 119, openings 113 communicating with the channel, spacer elements 446 and 447 defining cavity 450, and grooves 716 adapted for securing an o-ring. During operation of a separator assembly comprising central core element 440 flow through exhaust conduits is bi-directional. Flow direction arrows 448 and 449 illustrate the direction of the flow of concentrate and permeate respectively during operation of a separator assembly comprising the central core element 440 illustrated in FIG. 11.

In one embodiment, the present invention provides a salt separator assembly comprising a membrane stack assembly comprising at least one feed carrier layer, at least one permeate carrier layer, and at least one salt-rejecting membrane layer, the salt-rejecting membrane layer being disposed between the feed carrier layer and the permeate carrier layer. The salt separator assembly further comprises a central core element comprising at least one concentrate exhaust conduit and at least one permeate exhaust conduit wherein the concentrate exhaust conduit and the permeate exhaust conduit are separated by a first portion of the membrane stack assembly. A second portion of the membrane stack assembly forms a multilayer membrane assembly disposed around the central core element. The feed carrier layer is in contact with the concentrate exhaust conduit and is not in contact with the permeate exhaust conduit. The permeate carrier layer is in contact with the permeate exhaust conduit and is not in contact with the concentrate exhaust conduit. The permeate carrier layer does not form an outer surface of the salt separator assembly.

In one embodiment, the salt separator assembly comprises a multilayer membrane assembly which is radially disposed about the central core element. In another embodiment, the salt-rejecting membrane layer comprises a functionalized surface and an unfunctionalized surface. In one embodiment, the salt separator assembly comprises a plurality of concentrate exhaust conduits. In another embodiment, the salt separator assembly comprises a plurality of permeate exhaust conduits. In yet another embodiment, the salt separator assembly comprises a plurality of feed carrier layers, and in an alternate embodiment, the salt separator assembly comprises a plurality of permeate carrier layers. The salt separator assembly may comprise a plurality of salt-rejecting membrane layers.

In yet another embodiment, the present invention provides a spiral flow reverse osmosis membrane apparatus comprising (a) a pressurizable housing and (b) a separator assembly. The separator assembly comprises a membrane stack assembly comprising at least one feed carrier layer, at least one permeate carrier layer, and at least one membrane layer, the membrane layer being disposed between the feed carrier layer and the permeate carrier layer. The separator assembly also comprises a central core element comprising at least one concentrate exhaust conduit and at least one permeate exhaust conduit. A first portion of the membrane stack assembly is configured such that it separates the permeate exhaust conduit and the concentrate exhaust conduit. A second portion of the membrane stack assembly forms a multilayer membrane assembly disposed around the central core element. The feed carrier layer is in contact with the concentrate exhaust conduit and is not in contact with the permeate exhaust conduit. The permeate carrier layer is in contact with the permeate exhaust conduit and is not in contact with the concentrate exhaust conduit. Moreover, the permeate carrier layer does not form an outer surface of the separator assembly. The pressurizable housing comprises at least one feed inlet configured to provide feed solution to the outer surface of the separator assembly. The pressurizable housing comprises at least one permeate exhaust outlet coupled to the permeate exhaust conduit, and at least one concentrate exhaust outlet coupled to the concentrate exhaust conduit. The pressurizable housing may be made of suitable material or materials known to one of ordinary skill in the art. For example, the pressurizable housing may be made of a polymeric organic material, stainless steel, aluminum, glass, or a combination thereof. The feed inlet is connected to the pressurizable housing to enable input of the feed to the separator assembly. In one embodiment, the pressurizable housing comprises the thermoplastic ABS. In an alternate embodiment, the pressurizable housing comprises polycarbonate.

In one embodiment, the present invention provides a spiral flow reverse osmosis membrane apparatus comprising (a) a pressurizable housing and (b) a separator assembly provided by the present invention wherein the multilayer membrane assembly is radially disposed around the central core element. In an alternate embodiment, the present invention provides a spiral flow reverse osmosis membrane apparatus comprising (a) a pressurizable housing and (b) a plurality of separator assemblies provided by the present invention.

In still yet another embodiment, is provided a method for making a separator assembly, the method comprising: providing a central core element comprising at least one concentrate exhaust conduit and at least one permeate exhaust conduit; disposing a first portion of a membrane stack assembly comprising at least one permeate carrier layer, at least one feed carrier layer, and at least one membrane layer within the central core element such that the concentrate exhaust conduit and permeate exhaust conduit are separated by the first portion of the membrane stack assembly; and radially disposing a second portion of the membrane stack assembly around the central core element, and sealing a resultant wound assembly to provide a separator assembly wherein the concentrate exhaust conduit is not in contact with the permeate exhaust conduit, and wherein the feed carrier layer is in contact with the concentrate exhaust conduit and not in contact with the permeate exhaust conduit, and wherein the permeate carrier layer is in contact with the permeate exhaust conduit and not in contact with the concentrate exhaust conduit, and wherein the permeate carrier layer does not form an outer surface of the separator assembly.

In the present example, the expression “radially disposing a second portion of the membrane stack assembly around the central core element, and sealing a resultant wound assembly to provide a separator assembly” refers to the acts of winding the second portion of the membrane stack assembly around the central core element, applying sealing portions to the ends of the membrane stack assembly, for example sealing portions 316 and 317 of FIG. 3, and sealing the ends of the wound structure (e.g. the first and second surfaces of a cylindrical separator assembly), for example by dipping the ends of the wound structure in an epoxy sealant followed by curing.

In various embodiments, the separator assembly can be made using the procedures and concepts discussed herein and in the FIGS. 2-11. The methods disclosed herein afford separator assemblies in which folding of the membrane layer is avoided while providing for spiral flow of feed solution and permeate toward the concentrate exhaust conduit and permeate exhaust conduit disposed within the multilayer membrane assembly of the separator assembly. Other advantages, such as the decreased reliance on sealing portions relative to conventional separator assemblies, redound to the value of the various embodiments of the present invention disclosed herein. Those of ordinary skill in the art will appreciate that the present invention provides novel separator assemblies which can be operated without causing feed solution to flow along the axis of the multilayer membrane assembly (in a cross flow direction through the assembly). The separator assemblies provided by the present invention can be operated by introducing feed solution to the entire outer surface of the separator assembly thus minimizing the tendency of the separator assembly to telescope along its axis.

The separator assemblies provided by the present invention are especially useful for the separation of one or more solutes from a feed solution. In one embodiment, a separator assembly provided by the present invention is used to separate salt from seawater. In an alternate embodiment, the separator assembly provided by the present invention is used to separate a mixture of salt and organic contaminants from brackish water. Various feed solutions that may be advantageously separated into a permeate and a concentrate include seawater, brackish water, raw milk, food processing liquids, cooling tower effluent, municipal water treatment plant effluent, and municipal water sources such as river water, reservoir water and the like.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

1. A separator assembly comprising:
a membrane stack assembly comprising at least one feed carrier layer, at least one permeate carrier layer, and at least one membrane layer, the membrane layer being disposed between the feed carrier layer and the permeate carrier layer; and
a central core element comprising at least one concentrate exhaust conduit and at least one permeate exhaust conduit;
wherein the concentrate exhaust conduit and the permeate exhaust conduit are separated by a first portion of the membrane stack assembly; and
wherein a second portion of the membrane stack assembly forms a multilayer membrane assembly disposed around the central core element; and
wherein the feed carrier layer is in contact with the concentrate exhaust conduit and not in contact with the permeate exhaust conduit; and
wherein the permeate carrier layer is in contact with the permeate exhaust conduit and not in contact with the concentrate exhaust conduit; and
wherein the permeate carrier layer does not form an outer surface of the separator assembly.

2. The separator assembly of claim 1, wherein the multilayer membrane assembly is radially disposed around the central core element.

3. The separator assembly according to claim 1, wherein the separator assembly is a salt separator assembly.

4. The separator assembly according to claim 1, wherein the membrane layer comprises a functionalized surface and an unfunctionalized surface.

5. The separator assembly according to claim 1, comprising a plurality of concentrate exhaust conduits.

6. The separator assembly according to claim 1 comprising a plurality of permeate exhaust conduits.

7. The separator assembly according to claim 1, comprising a plurality of feed carrier layers.

8. The separator assembly according to claim 1 comprising a plurality of permeate carrier layers.

9. The separator assembly according to claim 1 comprising a plurality of membrane layers.

10. A salt separator assembly comprising:
a membrane stack assembly comprising at least one feed carrier layer, at least one permeate carrier layer, and at least one salt-rejecting membrane layer, the salt-rejecting membrane layer being disposed between the feed carrier layer and the permeate carrier layer; and
a central core element comprising at least one concentrate exhaust conduit and at least one permeate exhaust conduit;
wherein the concentrate exhaust conduit and the permeate exhaust conduit are separated by a first portion of the membrane stack assembly; and
wherein a second portion of the membrane stack assembly forms a multilayer membrane assembly disposed around the central core element; and
wherein the feed carrier layer is in contact with the concentrate exhaust conduit and not in contact with the permeate exhaust conduit; and
wherein the permeate carrier layer is in contact with the permeate exhaust conduit and not in contact with the concentrate exhaust conduit; and
wherein the permeate carrier layer does not form an outer surface of the salt separator assembly.

11. The salt separator assembly according to claim 10, wherein the multilayer membrane assembly is radially disposed around the central core element.

12. The salt separator assembly according to claim 10, wherein the salt-rejecting membrane layer comprises a functionalized surface and an unfunctionalized surface.

13. The salt separator assembly according to claim 10, comprising a plurality of concentrate exhaust conduits.

14. The salt separator assembly according to claim 10, comprising a plurality of permeate exhaust conduits.

15. The salt separator assembly according to claim 10, comprising a plurality of feed carrier layers.

16. The salt separator assembly according to claim 10, comprising a plurality of permeate carrier layers.

17. The salt separator assembly according to claim 10, comprising a plurality of salt-rejecting membrane layers.

18. A spiral flow reverse osmosis apparatus comprising:
(a) a pressurizable housing; and
(b) a separator assembly;
said separator assembly comprising a membrane stack assembly comprising at least one feed carrier layer, at least one permeate carrier layer, and at least one membrane layer, the membrane layer being disposed between the feed carrier layer and the permeate carrier layer; and
a central core element comprising at least one concentrate exhaust conduit and at least one permeate exhaust conduit;
wherein the concentrate exhaust conduit and the permeate exhaust conduit are separated by a first portion of the membrane stack assembly; and
wherein a second portion of the membrane stack assembly forms a multilayer membrane assembly disposed around the central core element; and
wherein the feed carrier layer is in contact with the concentrate exhaust conduit and not in contact with the permeate exhaust conduit; and
wherein the permeate carrier layer is in contact with the permeate exhaust conduit and not in contact with the concentrate exhaust conduit; and
wherein the permeate carrier layer does not form an outer surface of the separator assembly; and
wherein the pressurizable housing comprises at least one feed inlet configured to provide a feed solution to the outer surface of the separator assembly; and
wherein the pressurizable housing comprises at least one permeate exhaust outlet coupled to the permeate exhaust conduit, and at least one concentrate exhaust outlet coupled to the concentrate exhaust conduit.

19. The spiral flow reverse osmosis membrane apparatus according to claim 18, wherein the multilayer membrane assembly is radially disposed around the central core element.

20. A method of making a separator assembly comprising:
providing a central core element comprising at least one concentrate exhaust conduit and at least one permeate exhaust conduit;
disposing a first portion of a membrane stack assembly comprising at least one permeate carrier layer, at least one feed carrier layer, and at least one membrane layer within the central core element such that the concentrate exhaust conduit and permeate exhaust conduit are separated by the first portion of the membrane stack assembly; and
radially disposing a second portion of the membrane stack assembly around the central core element, and sealing a resultant wound assembly to provide a separator assembly,
wherein the concentrate exhaust conduit is not in contact with the permeate exhaust conduit, and
wherein the feed carrier layer is in contact with the concentrate exhaust conduit and not in contact with the permeate exhaust conduit, and
wherein the permeate carrier layer is in contact with the permeate exhaust conduit and not in contact with the concentrate exhaust conduit, and
wherein the permeate carrier layer does not form an outer surface of the separator assembly.

21. The method according to claim 20, wherein the central core element comprises a plurality of concentrate exhaust conduits.

22. The method according to claim 20, wherein the central core element comprises a plurality of permeate exhaust conduits.

23. The method according to claim 20, wherein the multilayer membrane assembly comprises a plurality of feed carrier layers.

24. The method according to claim 20, wherein the multilayer membrane assembly comprises a plurality of permeate carrier layers.

25. The method according to claim 20, wherein the multilayer membrane assembly comprises a plurality of membrane layers.
